(19) United States
(12) Patent Application Publication
(10) Pub. No.: US 2019/0008719 A1
(43) Pub. Date: Jan. 10, 2019

(54) Adjustable Physical Therapy Ball and Trigger Point Massage Device

(71) Applicants: Kevin E. Priebe, Cottonwood Heights, UT (US); Heather J. DeFord, Park City, UT (US)

(72) Inventors: Kevin E. Priebe, Cottonwood Heights, UT (US); Heather J. DeFord, Park City, UT (US)

(21) Appl. No.: 16/030,474

(22) Filed: Jul. 9, 2018

Related U.S. Application Data
(63) Continuation-in-part of application No. 29/655,134, filed on Jun. 29, 2018.
(60) Provisional application No. 62/529,857, filed on Jul. 7, 2017.

(51) Int. Cl. A61H 15/00; A61H 99/00

(52) U.S. Cl. CPC A61H 15/0092; A61H 2201/0192; A61H 2015/005; A61H 99/00

(57) ABSTRACT

An adjustable physical therapy ball and trigger point massage device consists of a first end ball, a second end ball, and at least one threaded rod. The first end ball and the second end ball are terminally and rotatably mounted onto the at least one threaded rod. At least one intermediate ball can be rotatably mounted along the at least one threaded rod in between the first end ball and the second end ball. A plurality of threads connecting the at least one intermediate ball and the at least one threaded rod allows the intermediate ball to move along the at least one threaded rod. If a larger surface area needs to be treated, a second threaded rod can be connected to a first threaded rod through a rod connector.

The current application claims a priority to the U.S. Provisional Patent application Ser. No. 62/529,857 filed on Jul. 7, 2017. The current application is filed on Jul. 9, 2018 while Jul. 7, 2018 was on a weekend.

### FIELD OF THE INVENTION

The present invention relates generally to a massage tool. More specifically, the present invention is a trigger point massage tool that consists of a set of balls and a threaded rod. A portion of the set of balls can move along the threaded rod.

### BACKGROUND OF THE INVENTION

Massage devices can be electronically powered or manually powered and are used for applying mild pressure or heat on sore or knotted muscle groups to alleviate stress, pain, and tension. Even though there are numerous benefits of existing massage devices, there are certain notable drawbacks as well.

The inability to maintain constant pressure is one main issue with existing massage devices. As an example, when using a massage device such as the foam roller, the user presses the body against the foam roller. If the user intends on reducing the pressure applied on a muscle, the user needs to change the body position. Changing the body position may not always be possible, especially if the user is nursing an injury.

The inability to use one massaging device throughout the body is another issue with existing massage devices. Since with a majority of massage devices, the overall structure is not adjustable, using the massage devices in a variety of anatomical areas can be troublesome. To address the issue, users tend to purchase multiple massage devices.

The objective of the present invention is to address the aforementioned issues. More specifically, the present invention introduces an adjustable physical therapy ball and trigger point massage device that can be adjusted according to the condition that is being treated and the individual who is being treated. The present invention is intended to be used for treating plantar fasciitis, Iliotibial (IT) band syndrome, piriformis syndrome and other comparable conditions. Thus, the present invention is a valuable tool for myofascial releasing and joint mobilizing for physical therapists, chiropractors, massage therapists, personal trainers, coaches, and personal use.

### BRIEF DESCRIPTION OF THE DRAWINGS

FIG. 1 is a perspective view of the present invention.

FIG. 2 is an exploded view of the first end ball, the end ball insert, and the end cap.

FIG. 3 is a perspective view of the first threaded rod.

FIG. 4 is another perspective view of the present invention, wherein at least one intermediate ball is positioned in between the first end ball and the second end ball.

FIG. 5 is a perspective exploded view of the at least one pair of center inserts and the at least one intermediate ball.

FIG. 6A is a perspective view of the present invention, wherein a first threaded rod and a second threaded rod is used with the first end ball and the second end ball.

FIG. 6B is perspective view of the present invention, wherein a second threaded rod and a plurality of intermediate balls are illustrated.

FIG. 7 is a perspective view of the rod connector.

FIG. 8 is a perspective exploded view of the first threaded rod, the rod connector, and the second threaded rod.

### DETAIL DESCRIPTIONS OF THE INVENTION

All illustrations of the drawings are for the purpose of describing selected versions of the present invention and are not intended to limit the scope of the present invention.

The present invention is an adjustable physical therapy ball and trigger point massage device that can be used for relieving muscle pain and joint pain. The adjustability of the present invention allows a user to massage a preferred muscle regardless of the musculature. As a result, the present invention can be used for treating the entire body of an individual.

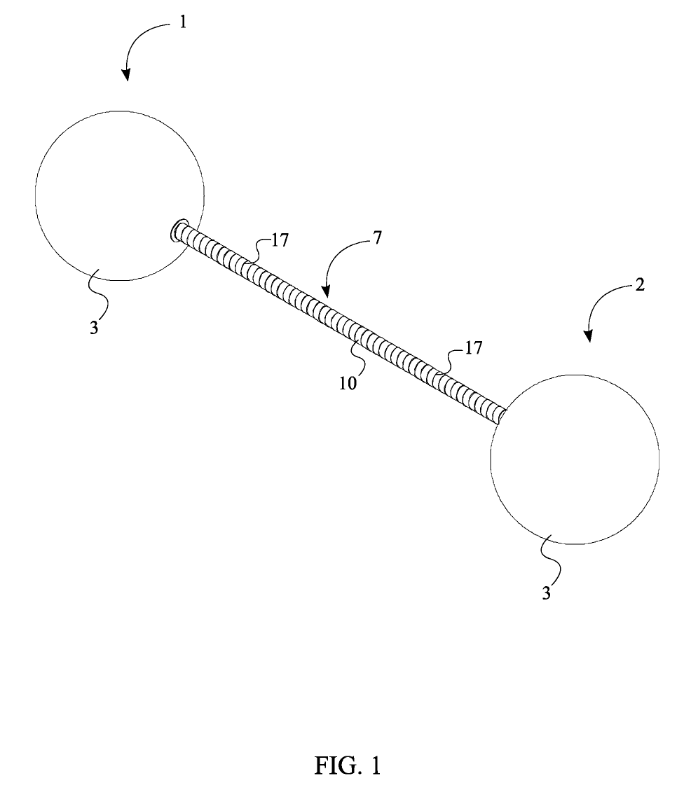

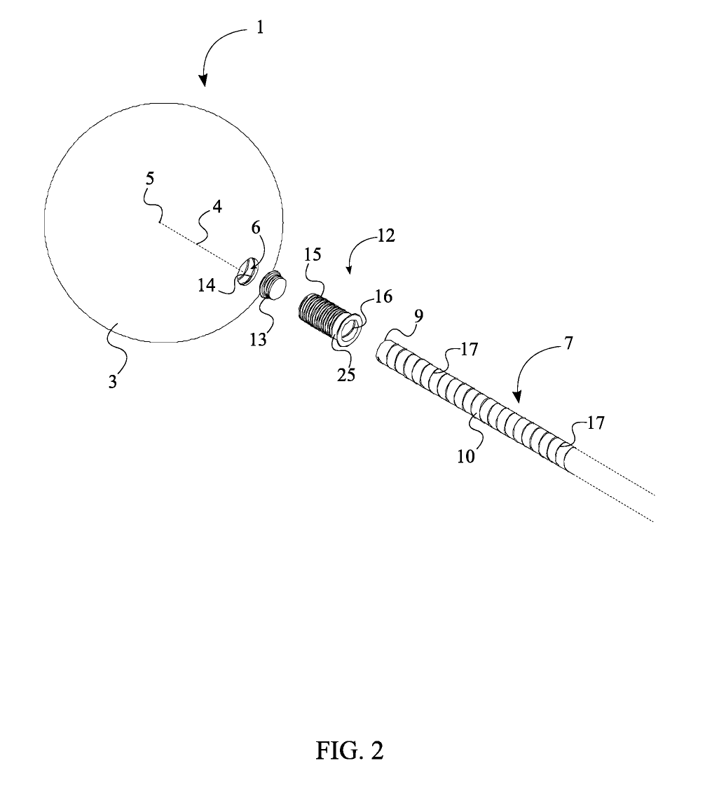

As shown in FIG. 1 and FIG. 2, to fulfill the intended functionalities, the present invention comprises a first end ball 1, a second end ball 2, at least one threaded rod 7, an end ball insert 12, and an end cap 13. The first end ball 1 and the second end ball 2 are used to execute the rolling motion of a massage process. The overall size of the first end ball 1 and the second end ball 2 can vary in different embodiments of the present invention. The at least one threaded rod 7 is used to connect the first end ball 1 and the second end ball 2 in one embodiment of the present invention. The end ball insert 12 and the end cap 13 are used to attach the at least one threaded rod 7 to the first end ball 1 and the second end ball 2.

As seen in FIG. 2, the first end ball 1 and the second end ball 2 each comprise a spherical body 3 and a rod-end receiving channel 6. The rod-end receiving channel 6 traverses into the spherical body 3 along a central axis 4 of the spherical body 3, wherein the central axis 4 intersects an origin 5 of the spherical body 3. In other words, the rod-end receiving channel 6 is positioned along a radius of the first end ball 1 and the second end ball 2. To secure the first end ball 1 and the second end ball 2, the end cap 13 is positioned within the rod-end receiving channel 6 of the first end ball 1 and the second end ball 2. In the resulting position, the end cap 13 is positioned adjacent the origin 5. To be removably attached to the end cap 13 within the rod-end receiving channel 6, the end ball insert 12 is positioned into the rod-end receiving channel 6 of the first end ball 1 and the second end ball 2. When the end cap 13 and the end ball insert 12 are appropriately positioned into the rod-end receiving channel 6, the first end ball 1 is terminally and rotatably mounted onto the at least one threaded rod 7. On the other hand, the second end ball 2 is terminally and rotatably mounted onto the at least one threaded rod 7 opposite the first end ball 1. Since the first end ball 1 and the second end ball 2 are rotatably mounted onto the at least one threaded rod 7, the present invention can be rolled along a surface area by executing a pushing motion and a pulling motion. Even though a spherical shape of the first end ball 1 and the second end ball 2 is used in the preferred embodiment, a comparable shape can be used in other embodiments of the present invention.

The positioning of the second end ball 2 can vary in different embodiments of the present invention. As seen in FIG. 1, in one embodiment of the present invention, when the at least one threaded rod 7 is a single rod, the first end ball 1 is terminally connected to the single rod. On the other hand, the second end ball 2 is terminally connected opposite the first end ball 1 and along the single rod. The length of the single rod can vary in different embodiments of the present invention.

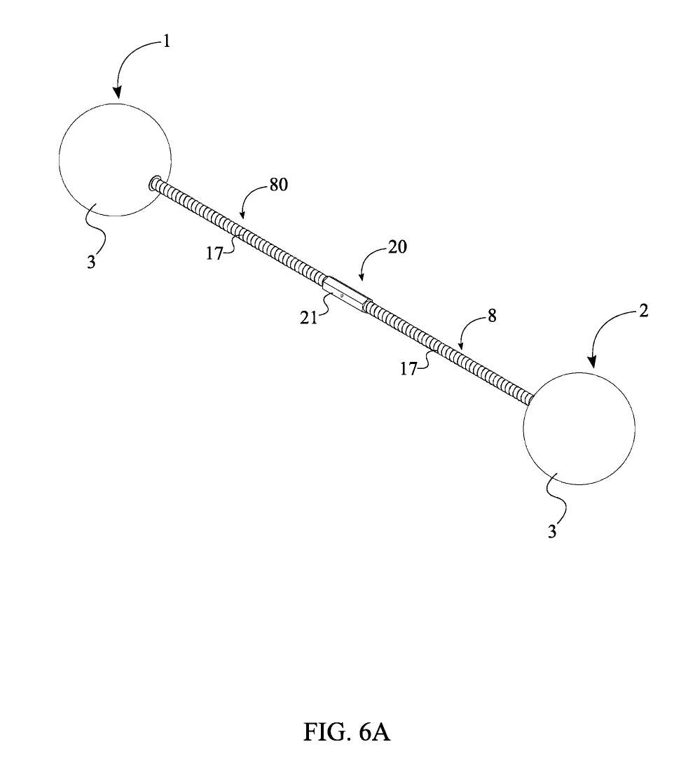

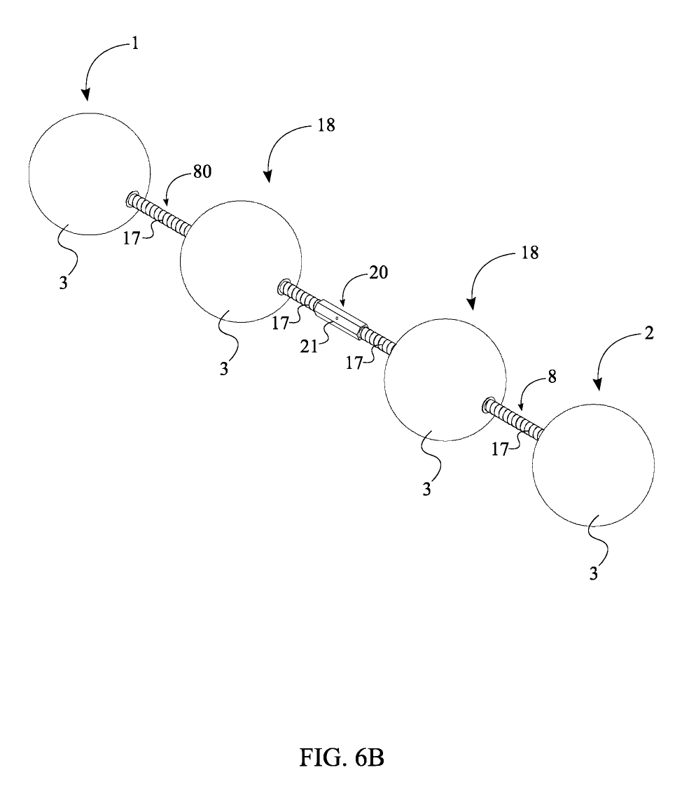

As seen in FIG. 6A, in another embodiment of the present invention, when the at least one threaded rod 7 comprises a first threaded rod 80 and a second threaded rod 8, the first end ball 1 is terminally connected to the first threaded rod 80. On the other hand, the second end ball 2 is terminally connected to the second threaded rod 8. Moreover, the first threaded rod 80 is positioned adjacent the second threaded rod 8. When being configured for use, the first end ball 1 is positioned opposite the second threaded rod 8 along the first threaded rod 80. On the other hand, the second end ball 2 is positioned opposite the first threaded rod 80 along the second threaded rod 8.

As further illustrated in FIG. 2, to appropriately position the end ball insert 12 into the rod-end receiving channel 6, the first end ball 1 and the second end ball 2 each comprise a first plurality of engagement threads 14. To engage with the first plurality of engagement threads 14, the end ball insert 12 comprises a second plurality of engagement threads 15. The first plurality of engagement threads 14 is internally distributed along the rod-end receiving channel 6. To correspond with the first plurality of engagement threads 14, the second plurality of engagement threads 15 is externally distributed along an insert body 25 of the end ball insert 12. When the end ball insert 12 is positioned into the rod-end receiving channel 6, the first plurality of engagement threads 14 is engaged with the second plurality of engagement threads 15. As a result, the end ball insert 12 is secured within the rod-end receiving channel 6 of the first end ball 1 and the second end ball 2.

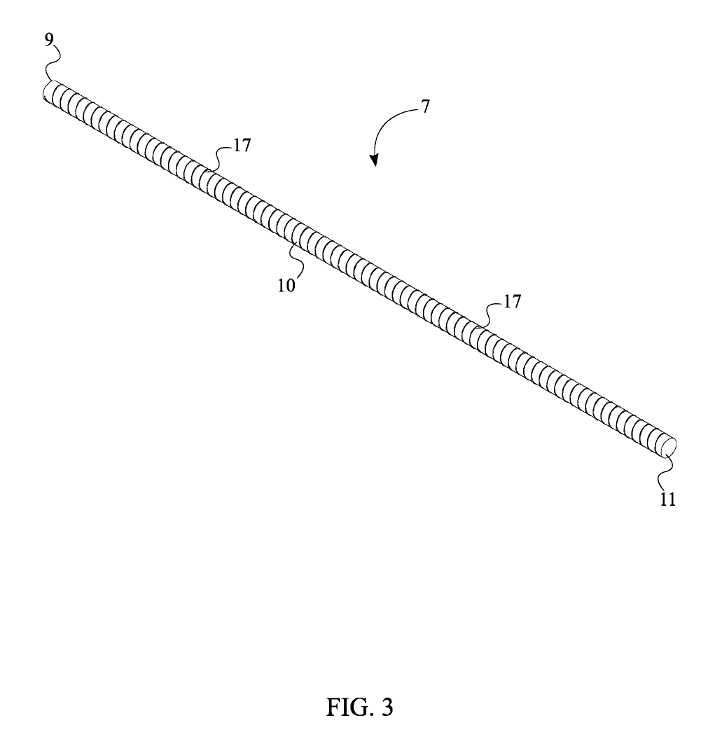

As discussed before and as shown in FIG. 1, the at least one threaded rod 7 is used to mount the first end ball 1 and the second end ball 2. As shown in FIG. 2 and FIG. 3, to do so, the at least one threaded rod 7 comprises a first end 9, a rod body 10, and a second end 11. The rod body 10 extends from the first end 9 to the second end 11 and determines an overall length of the at least one threaded rod 7. The overall length of the at least one threaded rod 7 can vary in different embodiments of the present invention. A diameter of the at least one threaded rod 7 is selected so that the first end 9 and the second end 11 snugly fit within the end ball insert 12.

As illustrated in FIG. 2 and FIG. 3, to attach the at least one threaded rod 7 to the end ball insert 12 that is positioned within the first end ball 1 and the second end ball 2, the end ball insert 12 further comprises a third plurality of engagement threads 16. Moreover, the at least one threaded rod 7 comprises a fourth plurality of engagement threads 17. The third plurality of engagement threads 16 is internally distributed along the insert body 25. More specifically, the third plurality of engagement threads 16 is positioned opposite the second plurality of engagement threads 15 across the insert body 25. On the other hand, the fourth plurality of engagement threads 17 is externally distributed along the rod body 10 from the first end 9 to the second end 11. Thus, when the first end 9 of the at least one threaded rod 7 is attached to the end ball insert 12 within the first end ball 1, the third plurality of engagement threads 16 is engaged with the fourth plurality of engagement threads 17. Likewise, when the second end 11 of the at least one threaded rod 7 is attached to the end ball insert 12 within the second end ball 2, the third plurality of engagement threads 16 is engaged with the fourth plurality of engagement threads 17.

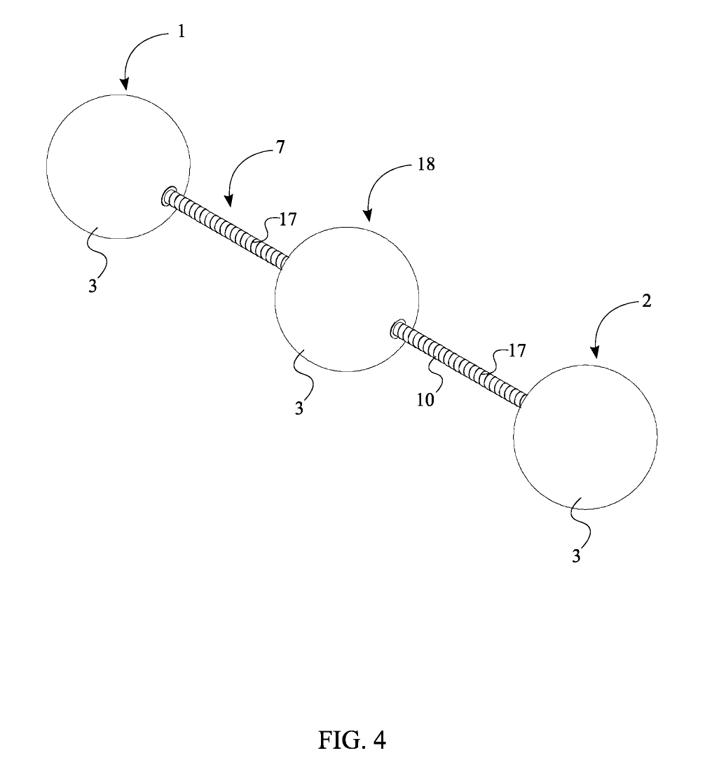

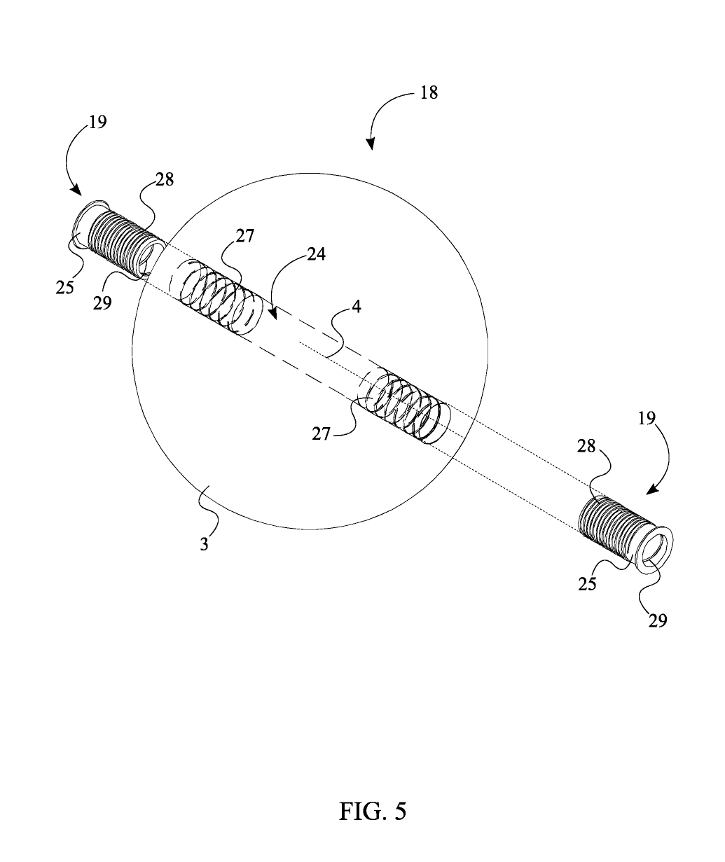

The massaging technique and the massaging device varies according to the musculature of the area that needs to be treated. As an example, a massaging device that is used for treating shin splints can be different from a massaging device used to massaging the back of a user. As shown in FIG. 4 and FIG. 5, to be used with different muscle groups, the present invention further comprises at least one intermediate ball 18 and at least one pair of center inserts 19. Similar to the first end ball 1 and the second end ball 2, the at least one intermediate ball 18 comprises a spherical body 3. However, since the at least one intermediate ball 18 is positioned in between the first end ball 1 and the second end ball 2, the at least one intermediate ball 18 comprises a rod-body receiving channel 24 that traverses through the spherical body 3 along a central axis 4 of the spherical body 3. Similar to the first end ball 1 and the second end ball 2, the central axis 4 of the at least one intermediate ball 18 intersects an origin 5 of the spherical body 3. In other words, the rod-body receiving channel 24 is positioned along a diameter of the at least one intermediate ball 18. The at least one pair of center inserts 19 is used in the process of positioning the at least one threaded rod 7 through the at least one intermediate ball 18. To do so, the at least one pair of center inserts 19 is positioned within the rod-body receiving channel 24 wherein each of the at least one pair of center inserts 19 is positioned adjacent to each other. After the at least one pair of center inserts 19 is positioned within the rod-body receiving channel 24, the rod body 10 of the at least one threaded rod 7 is positioned through the at least one pair of center inserts 19. In the resulting position, the at least one intermediate ball 18 is rotatably mounted onto the rod body 10 so that the at least one intermediate ball 18 can be positioned at a preferred position along the at least one threaded rod 7.

As seen in FIG. 5, to position the at least one pair of center inserts 19 within the rod-body receiving channel 24, the at least one intermediate ball 18 comprises a fifth plurality of engagement threads 27. Moreover, the at least one pair of center inserts 19 each comprise a sixth plurality of engagement threads 28. The fifth plurality of engagement threads 27 is internally distributed along the rod-body receiving channel 24. To correspond with the fifth plurality of engagement threads 27, the sixth plurality of engagement threads 28 is externally distributed along an insert body 25 of each of the at least one pair of center inserts 19. When the at least one pair of center inserts 19 is positioned within the rod-body receiving channel 24, the fifth plurality of engagement threads 27 is engaged with the sixth plurality of engagement threads 28.

As further illustrated in FIG. 5, to receive the rod body 10 and facilitate the movement of the at least one intermediate ball 18 along the rod body 10, the at least one pair of center inserts each comprise a plurality of rod body-engaging threads 29. To engage with the fourth plurality of engagement threads 17 of the at least one threaded rod 7, the plurality of rod body-engaging threads 29 is internally distributed along the insert body 25 of each of the at least one pair of center inserts 19. When the at least one threaded rod 7 traverses through the at least one intermediate ball 18, the plurality of rod body-engaging threads 29 is engaged with the fourth plurality of engagement threads 17.

In addition to being used with different musculatures, the present invention can also be used to treat varying surface areas. As an example, the present invention can be used to treat piriformis syndrome in one embodiment of the present invention. In another embodiment, the present invention can be used to treat the back of an individual.

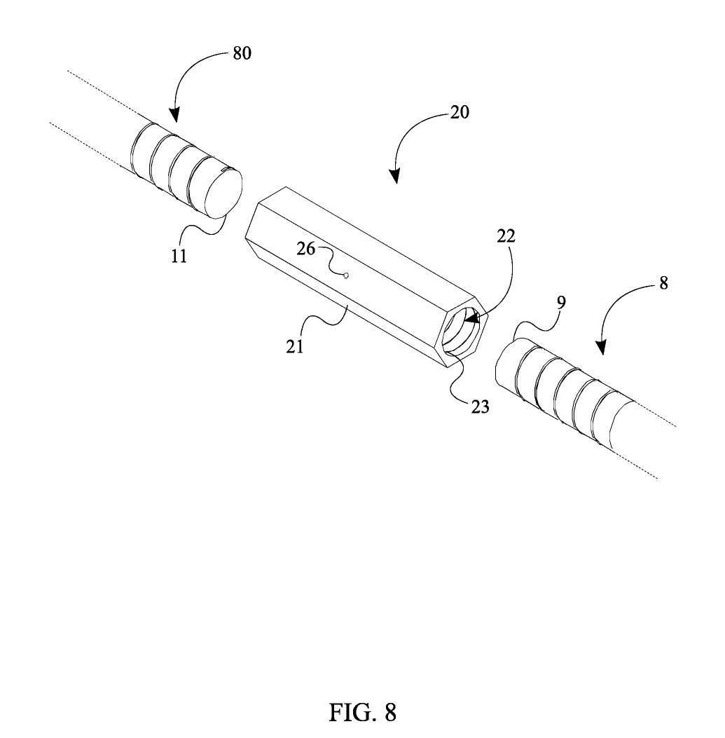

As seen in FIG. 6A and FIG. 6B, when the present invention is used to treat a larger surface area, the at least one threaded rod 7 comprises the first threaded rod 80 and the second threaded rod 8 in another embodiment of the present invention. To connect the first threaded rod 80 and the second threaded rod 8, the present invention further comprises a rod connector 20. Both the first threaded rod 80 and the second threaded rod 8 each comprise a first end 9, a rod body 10, and a second end 11. The rod body 10 extends from the first end 9 to the second end 11. When the first threaded rod 80 and the second threaded rod 8 are used as the at least one threaded rod 7, the first end ball 1 is terminally and rotatably mounted onto the first end 9 of the first threaded rod 80. Next as seen in FIG. 8, the second end 11 of the first threaded rod 80 is removably attached to the rod connector 20. The first end 9 of the second threaded rod 8 is removably attached to the rod connector 20 opposite the first threaded rod 80. In the resulting position, the second end 11 of the at least one threaded rod 80 is positioned adjacent the first end 9 of the second threaded rod 8 within the rod connector 20. Next the second end ball 2 is terminally and rotatably mounted onto the second end 11 of the second threaded rod 8. Thus, the second end ball 2 is positioned offset from the second end 11 of the first threaded rod 80.

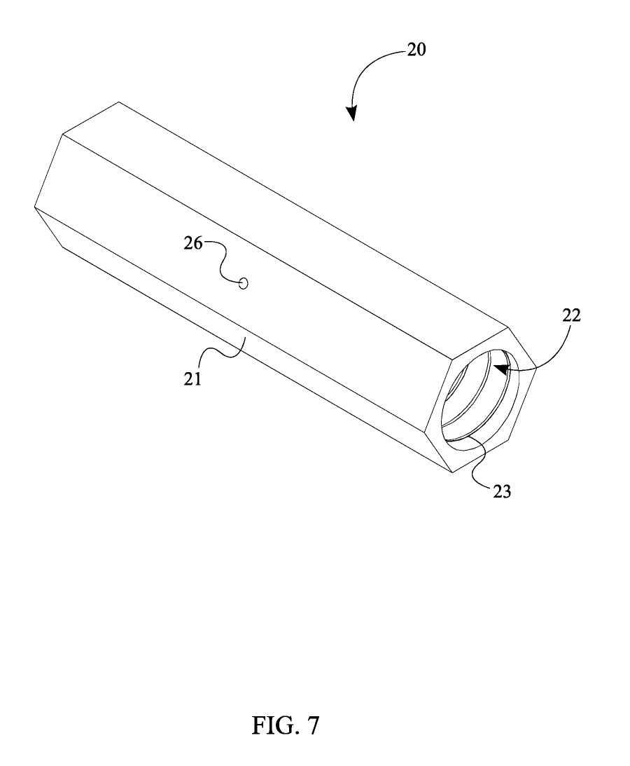

As shown in FIG. 7, to connect the at least one threaded rod 80 and the second threaded rod 8, the rod connector 20 in the preferred embodiment comprises a connector body 21, a connector channel 22, and a set of internal threads 23. The connector channel 22 traverses through and along the connector body 21 and has a diameter matching an outside diameter of the first threaded rod 80 and the second threaded rod 8. Thus, the first threaded rod 80 and the second threaded rod 8 can be inserted into the connector channel 22. The set of internal threads 23 is internally distributed along the connector channel 22 allowing the first threaded rod 80 and the second threaded rod 8 to be removably attached to the rod connector 20. More specifically, the set of internal threads 23 is engaged with the fourth plurality of engagement threads 17. As further illustrated in FIG. 7, in the preferred embodiment of the rod connector 20, a separation pin 26 perpendicularly traverses into the connector body 21. The separation pin 26 ensures that the second end 11 of the first threaded rod 80 and the first end 9 of the second threaded rod 8 are not pressed against each other.

When the present invention is being used, the following process flow is generally followed. Initially, the first end ball 1 is mounted at the first end 9 of the at least one threaded rod 7 and the second end ball 2 is mounted at the second end 11 of the at least one threaded rod 7 when the at least one threaded rod 7 is a single rod. The end ball insert 12 and the end cap 13 are used in the process of mounting the first end ball 1 and the second end ball 2. The overall length of the at least one threaded rod 7 and the overall diameter of the first end ball 1 and the second end ball 2 can vary in different embodiments of the present invention. If the treatment process requires concentrated massaging, the at least one intermediate ball 18 can be positioned along the rod body 10 in between the first end ball 1 and the second end ball 2. If additional surface area needs to be covered during a massage session, the second threaded rod 8 is attached to the first threaded rod 80 via the rod connector 20. In such instances, the first end ball 1 is attached to the first end 9 of the first threaded rod 7 and the second end ball 2 is attached to the second end 11 of the second threaded rod 8. The at least one intermediate ball 18 or a plurality of intermediate balls can be positioned along the rod body 10 of the first threaded rod 80 or the second threaded rod 8.

Although the invention has been explained in relation to its preferred embodiment, it is to be understood that many other possible modifications and variations can be made without departing from the spirit and scope of the invention as hereinafter claimed.

What is claimed is:

1. An adjustable physical therapy ball and trigger point massage device comprises:
a first end ball;
a second end ball;
at least one threaded rod;
an end ball insert;
an end cap;
the first end ball and the second end ball each comprise a spherical body and a rod-end receiving channel;
the rod-end receiving channel traversing into the spherical body along a central axis of the spherical body, wherein the central axis intersects an origin of the spherical body;
the end cap being positioned within the rod-end receiving channel of the first end ball and the second end ball, wherein the end cap is positioned adjacent the origin;
the end ball insert being positioned into the rod-end receiving channel of the first end ball and the second end ball;
the end cap being removably attached to the end ball insert within the rod-end receiving channel;
the first end ball being terminally and rotatably mounted onto the at least one threaded rod; and
the second end ball being terminally and rotatably mounted onto the at least one threaded rod opposite the first end ball.

2. The adjustable physical therapy ball and trigger point massage device as claimed in claim 1 further comprises:
wherein the at least one threaded rod is a single rod;
the first end ball being terminally connected to the single rod; and
the second end ball being terminally connected opposite the first end ball and along the single rod.

3. The adjustable physical therapy ball and trigger point massage device as claimed in claim 1 further comprises:
wherein the at least one threaded rod comprises a first threaded rod and a second threaded rod;
the first end ball being terminally connected to the first threaded rod;
the second end ball being terminally connected to the second threaded rod;
the first threaded rod being positioned adjacent the second threaded rod;
the first end ball being positioned opposite the second threaded rod along the first threaded rod; and
the second end ball being positioned opposite the first threaded rod along the second threaded rod.

4. The adjustable physical therapy ball and trigger point massage device as claimed in claim 1 further comprises:
the first end ball and the second end ball each comprise a first plurality of engagement threads;
the end ball insert comprises a second plurality of engagement threads;
the first plurality of engagement threads being internally distributed along the rod-end receiving channel;
the second plurality of engagement threads being externally distributed along an insert body of the end ball insert; and
the first plurality of engagement threads being engaged with the second plurality of engagement threads.

5. The adjustable physical therapy ball and trigger point massage device as claimed in claim 1 further comprises:
the at least one threaded rod comprises a first end, a rod body, and a second end; and
the rod body extending from the first end to the second end,

6. The adjustable physical therapy ball and trigger point massage device as claimed in claim 1 further comprises:
the first end ball and the second end ball each comprise a third plurality of engagement threads;
the at least one threaded rod comprises a fourth plurality of engagement threads;
the third plurality of engagement threads being internally distributed along an insert body of the end ball insert;
the fourth plurality of engagement threads being externally distributed along a rod body of the at least one threaded rod; and
the third plurality of engagement threads being engaged with the fourth plurality of engagement threads.

7. The adjustable physical therapy ball and trigger point massage device as claimed in claim 1 further comprises:
at least one intermediate ball;
at least one pair of center inserts;
the at least one intermediate ball comprises a spherical body and a rod-body receiving channel;
the rod-body receiving channel traversing through the spherical body along a central axis of the spherical body, wherein the central axis intersects an origin of the spherical body;
the at least one pair of center inserts being positioned within the rod-body receiving channel, wherein each of the pair inserts is positioned adjacent to each other; and
a rod body of the at least one threaded rod being positioned through the pair of inserts, wherein the at least one intermediate ball is rotatably mounted onto the rod body.

8. The adjustable physical therapy ball and trigger point massage device as claimed in claim 7 further comprises:
the at least one intermediate ball comprises a fifth plurality of engagement threads;
the at least one pair of center inserts each comprise a sixth plurality of engagement threads;
the first plurality of engagement threads being internally distributed along the rod-body receiving channel;
the second plurality of engagement threads being externally distributed along an insert body of each of the at least one pair of center inserts; and
the first plurality of engagement threads being engaged with the second plurality of engagement threads.

9. The adjustable physical therapy ball and trigger point massage device as claimed in claim 7 further comprises:
the at least one pair of center inserts each comprise a plurality of rod body-engaging threads;
the at least one threaded rod comprises a fourth plurality of engagement threads;
the plurality of rod body-engaging threads being internally distributed along an insert body of the at least one pair of center inserts;
the fourth plurality of engagement threads being externally distributed along a rod body of the at least one threaded rod; and
the plurality of rod body-engaging threads being engaged with the fourth plurality of engagement threads.

10. The adjustable physical therapy ball and trigger point massage device as claimed in claim 1 further comprises:
wherein the at least one threaded rod comprises a first threaded rod and a second threaded rod;
a rod connector;
the first threaded rod and the second threaded rod each comprise a first end, a rod body, and a second end;
the rod body extending from the first end to the second end;
the second end of the first threaded rod being removably attached to the rod connector; and
the first end of the second threaded rod being removably attached to the rod connector opposite the first threaded rod.

11. The adjustable physical therapy ball and trigger point massage device as claimed in claim 10 further comprises:
the rod connector comprises a connector body, a connector channel, and a set of internal threads;
the connector channel traversing through and along the connector body; and
the set of internal threads being internally distributed along the connector channel.
